(19) United States
(12) Patent Application Publication
(10) Pub. No.: US 2024/0007743 A1
(43) Pub. Date: Jan. 4, 2024

(54) TERMINAL, METHOD FOR CONTROLLING THE TERMINAL, COMPUTER PROGRAM AND STORAGE MEDIUM

(71) Applicant: Robert Bosch GmbH, Stuttgart (DE)

(72) Inventor: Christoph Burger-Scheidlin, Muenchen (DE)

(21) Appl. No.: 18/255,149

(22) PCT Filed: Oct. 25, 2021
(86) PCT No.: PCT/EP2021/079478

§ 371 Date: May 31, 2023

(30) Foreign Application Priority Data
Dec. 3, 2020 (DE) 10 2020 215 258.6

(51) Int. Cl. H04N 23/661; H04N 23/62; H04N 23/667; H04N 23/695

(52) U.S. Cl. CPC H04N 23/661; H04N 23/695; H04N 23/667; H04N 23/62

(57) ABSTRACT

It is known that a multiplicity of devices receive data from the cloud and make specific changes of state on the basis of these data. An example that can be mentioned is switching on a lamp or changing a color of a light source. A terminal (2) for controlling at least one actuator arrangement is proposed, wherein the actuator arrangement can adopt a plurality of states, having at least one software component (5), wherein the software component (5) can request a state and/or a change of state of the actuator arrangement by way of a request (A2, A3), having a central component (4), wherein the central component (4) comprises a cloud interface (6) for communicating with a cloud (13) and at least one component interface (7) for communicating with the software component (5), wherein the cloud interface (6) and/or the component interface (7) can be used to request a state and/or a change of state of the actuator arrangement by way of a request (A1, A2, A3), having an output interface (10) for controlling the actuator arrangement, wherein the central component (4) is configured to orchestrate the requested states (A1, A2, A3) and/or changes of state, wherein the terminal (2) is configured as a controller of a safety system component.

### BACKGROUND

It is known that a multiplicity of devices receive data from the cloud and make specific changes of state on the basis of these data. One example of this is switching on a lamp or changing a color of a light source.

A video system for displaying image data is known from the publication DE 10 2012 202 315 A1, which probably constitutes the closest prior art, wherein image data, such as video sequences, are stored on servers, loaded as required by means of a client connected to the server via a network and displayed on the client.

### SUMMARY

The invention relates to a terminal, a camera device, a method, a computer program, and a storage medium.

The subject matter of the invention is a terminal, wherein the terminal is suitable and/or configured for controlling at least one actuator arrangement. The terminal can in particular be configured as UE—user equipment. The actuator arrangement can adopt a plurality of states.

The actuator arrangement can comprise one or more actuators. Using these actuators, the actuator arrangement can adopt a plurality of states, wherein the states are differentiated in particular by the position of the actuators. The change from one state to a next state takes place via a change of state.

The terminal comprises at least one software component, wherein the software component can request a state and/or a change of state of the actuator arrangement via a request. The terminal preferably comprises more than one such software component. Thus, multiple software components can make requests for a state and/or a change of state of the actuator arrangement. The software component is understood to be an application software, an application program, a software, a computer program and/or an app. The terminal is configured as or comprises a digital data processing device, such as a computer or microcontroller.

The terminal comprises a central component, wherein the central component is preferably configured as a software module. The terminal in particular comprises an operating system, wherein the central component is configured as a component of the operating system.

The central component comprises a cloud interface for communicating with a cloud. Cloud is in particular understood to mean an IT infrastructure that is made available via the Internet, for example. The cloud is in particular configured as a computer network. The cloud can in particular provide a variety of service models, specifically infrastructure as a service (IaaS), platform as a service (PaaS), software as a service (SaaS), and/or function as a service (FaaS). The cloud does not have to be physically remote, but can also be understood to mean an edge cloud or an IT infrastructure in the same network (“on premise”). The minimum case of a cloud is a single server.

In the cloud, at least one service is provided by a service component. The service component is understood to be an application software, an application program, a software, a computer program and/or an app that can run in the cloud. The service can request a state and/or a change of state of the actuator arrangement via a request. Requesting the state and/or the change of state is takes place via the cloud interface for communicating with the cloud. A request for a state and/or a change of state is thus transmitted to the central component via the cloud interface. The cloud interface can be configured as a hardware interface, but it is also possible for the cloud interface to be implemented as a software interface. A combination of hardware and software interface is possible as well.

The central component further comprises at least one component interface for communicating with the at least one software component, the central component preferably comprises a plurality of such component interfaces. Requests for a state and/or a change of state of the actuator arrangement can be transmitted to the central component via the component interface.

Requests for a state and/or a change of state can thus be transmitted to the central component via the cloud interface as well as via at least one or several component interfaces.

The terminal comprises an output interface for controlling the actuator arrangement. The output interface can be configured as an analog interface or as a digital interface.

It is provided that the central component be configured in terms of programming and/or circuitry to orchestrate the requested states and/or the requested changes of state. The orchestration in particular includes the flexible and/or rule-based combining of multiple requests into an action sequence as a composition. The orchestration in particular includes arranging the requests and/or requested states into an executable sequence, wherein the actuator arrangement is configured to process the action sequence and/or the arranged requests and/or states and/or changes of state.

In the context of the invention, it is proposed that the terminal be configured as a controller of a safety component. The safety component can, for instance, be configured as an access control system, an intrusion alarm system, a fire alarm system, etc. A plurality of in particular competing software components can be installed in the aforementioned systems, so that the orchestration leads to an advantageous organization of the requests. The safety components are in particular configured such that they are operated exclusively or at least largely in normal operation via requests that are transmitted to the terminal via the cloud interface and/or the component interface.

Preferably, it is proposed that the terminal is configured as a camera controller and/or the actuator arrangement is configured as a camera unit.

The advantage of the invention is that the software components and the service component can be developed independently of one another in the cloud and nonetheless control the same camera unit without creating a conflict of requests. The service component can be provided in the cloud by a manufacturer of the terminal and/or the actuator arrangement, for instance. The at least one software component, on the other hand, can be provided on the terminal by other developers. It is also possible that the software components on the terminal can be flexibly downloaded from an app store or the like and installed on the terminal. The invention thus describes a mechanism for ensuring an efficient and smooth operation of a modularized software system, without all of the modules having been coordinated with one another for this purpose. The terminal thus comprises a software system that is capable of being expanded by software components as software modules. The software components, in particular software modules, can be applied to the terminal at any time and can have been developed by third parties.

The central component is preferably a part of the base system and/or operating system of the terminal and controls communication with the outside world, in particular with the cloud. This architecture enables the central component to orchestrate communication with the other software components and the outside world, in particular the cloud, and thus prevent conflicts caused by contradictory requests. It is therefore a matter of monitoring and orchestrating communication processes taking into account the device-specific context of a camera device. The central component makes it possible to develop service components in the cloud and software components on the terminal independently of one another and nonetheless sufficiently ensure that the software modules do not conflict with one another.

In a preferred embodiment of the invention, at least one, some, or all of the component interfaces are optionally respectively configured as an application programming interface, in particular as an API. The at least one component interface is in particular a program part that is provided by the central component of the at least one software component for connection to the central component. This embodiment allows software components to also be developed, provided and installed on the terminal by third-party developers as third-party components at any later time using the application programming interface.

In a preferred embodiment of the invention, the actuator arrangement comprises at least one pan module and/or tilt module and/or zoom module. The actuator arrangement can comprise at least one or two or more of the modules as actuators. The terminal is configured to control the aforementioned modules. The actuator arrangement can in particular be controlled via the output interface to transfer said modules, and thus the actuator arrangement, to a requested state. The terminal can comprise further modules, such as a drive module, so that the terminal and/or the camera unit can be moved to different locations.

In one possible further development of the invention, it comprises a sound recording module and/or a sound output module as actuators. The terminal is configured to control the aforementioned modules. The actuator arrangement can in particular be controlled via the output interface to transfer said modules, and thus the actuator arrangement, to a requested state.

The requested state in particular includes parameters for at least one, some, or all of the aforementioned modules.

In one possible further development of the invention, the at least one software component is assigned a component priority. The central component is configured to orchestrate the requests of the software component and/or via the cloud interface, taking into account the component priority. The priorities can be set numerically in a simple manner: a first software component receives the component priority 1, a second software component receives the component priority 2 and a third software component receives the component priority 3, for instance. Optionally, the cloud or its requests are likewise assigned a priority in the schema. If requests from the software components arrive at the same time or at least overlapping in time, the request with component priority 1 is processed first, followed by the request with component priority 2 and then the request with component priority 3. In this embodiment, therefore, component priorities are assigned to the software components.

The priorities can also be regulated via the permissions of the software components. For example, it is conceivable that an “override user” permission exists, with which this software component is granted a high change priority by the central component. Alternatively, the software component can be a “safety-critical” software component, such as a software component for fire detection. This type of the software component can then be granted a change priority over a “security-relevant” software component. In this configuration, change priorities are thus assigned to the requests based on the permissions of the software components.

It is also possible for a set of rules to be provided to prioritize the requests.

If conflicts arise, they are resolved by assigning or taking into account the different priorities; i.e., a currently active software component is giving priority. This priority can continue for a specific period of time, e.g., to prevent a software component from controlling the camera unit even though someone is still viewing the video image in the cloud via the corresponding service.

In a preferred embodiment of the invention, the orchestration includes sorting the sequence of requests. The requests are in particular sorted with respect to time and output sequentially. An action sequence is output via the output interface on the basis of the sorted requests. The action sequence is laid out as a succession of changes of state and/or states for the camera unit, in particular control commands for changes of state and/or states for the camera unit.

In possible embodiments of the invention, the states and/or changes of state are arranged in the action sequence in series and/or sequentially. This is the case in particular when the states or changes of state in the action sequence mutually exclude each other. However, it is also possible for states and/or changes of state to be arranged in the action sequence in parallel. This is possible in particular when the states do not mutually exclude each other. This is the case, for instance, when a requested state involves positioning modules of the camera unit, such as the pan module, the tilt module or the zoom module, but another requested state involves the audio modules, such as the sound recording module and/or sound output module. These types of modules can be changed independently of one another and corresponding changes of state or requested states can therefore be arranged in the action sequence in parallel.

A further subject matter of the invention relates to a camera device, wherein the camera device comprises the terminal as described above. The camera device also comprises the actuator arrangement configured as the camera unit. The terminal is configured to control the actuator arrangement or the camera unit.

The camera device is particularly preferably configured as a structural unit and/or a closed assembly.

A further subject matter of the invention relates to a method for controlling the terminal described above and/or the camera device as described above.

The method includes the steps of accepting at least one request for a state and/or a change of state of the camera unit from the cloud and/or from one of the software components. Preferably, at least two such requests are present at the same time and/or overlapping in time. In a further step, the requested states and/or changes of state are orchestrated. The requests, the states and/or the changes of state are sorted in a sequence, in particular a chronological sequence and/or in an action sequence. The requests, states and/or changes of state and/or the action sequence are then output to the camera unit via the output interface.

In one preferred embodiment, at least one of the software components has been installed on the terminal at a later time as an application program.

A further subject matter of the invention relates to a computer program. A further subject matter of the invention relates to a storage medium.

### BRIEF DESCRIPTION OF THE DRAWINGS

Further features, advantages and effects of the invention will emerge from the following description of a preferred embodiment of the invention and the accompanying figures. The figures show:

FIG. 1 a schematic block diagram of a camera device as an embodiment example of the invention.

### DETAILED DESCRIPTION

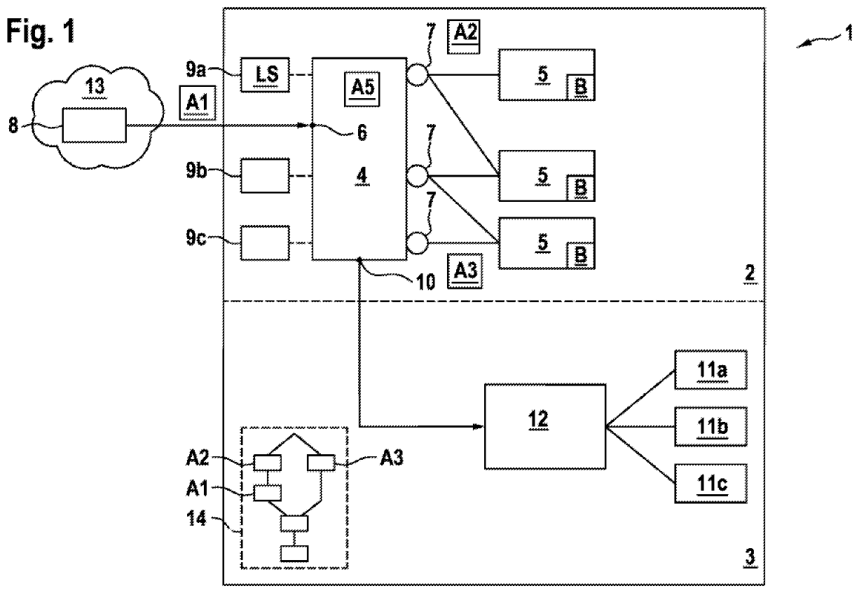

FIG. 1 shows a schematic block diagram of a camera device 1 as an embodiment example of the invention. The camera device 1 comprises a terminal 2 and a camera unit 3. The camera device 1 is configured as an integral structural unit, for example.

The terminal 2 comprises a central component 4 and a plurality of the software components 5. The software components 5 are in particular configured as apps, as application programs. The central component 4 can be part of an operating system of the terminal 2.

The central component 4 comprises a cloud interface 6, wherein the central component 4 is data technologically connected to a cloud 13 via the cloud interface 6. One or more servers 8 are disposed in the cloud 13, wherein the server 8 provides services associated with the camera device 1. One component of the operating system is responsible for establishing a connection to the server 8 in the cloud 13. The connection to this server 8 is made using a generic protocol, so that there is no need for the server 8 to understand the operating principle of the camera device 1. A downstream system (not shown) can use the server 8 to communicate with the camera device 1.

The central component 4 further comprises a plurality of component interfaces 7, wherein the central component 4 is data technologically connected to the software components 5 via the component interfaces 7. The component interfaces 7 can be configured as common APIs (application programming interfaces), but can also be configured as function-specific APIs, so that one of the software components 5 addresses a plurality of component interfaces 7 to request multiple functions.

The camera device 1, in particular the terminal 2, comprises a plurality of memory modules 9a, b, c, wherein the memory modules 9a, b, c are data technologically connected to the central component 4.

The terminal 2 comprises an output interface 10, wherein the output interface 10 is data technologically connected to the central component 4.

The camera unit 2 is configured as an actuator arrangement and, for instance, comprises a pan module 11a, a tilt module 11b and a zoom module 11c and optionally further modules, such as a sound recording module and/or a sound output module, as actuators that are used to manipulate parameters of the camera unit 2. The camera unit 2 comprises a control device 12, wherein the control device 12 is data technologically connected to the output interface 10. The control device 12 can alternatively also be a component of the terminal 2.

The operating system, including several central components that form or contribute to forming the central component 4, as well as additional modules (apps) and the software components 5 that communicate with the central component 4 via particular function-specific APIs as component interfaces 7 are located on the camera device 1, in particular on the terminal 2. A software component 5 can request the movement of the camera to a specific position, for instance, or require specific image processing settings. The software components 5 can thus transmit requests relating to the state and/or change of state of the actuator arrangement and/or the camera unit 2 to the central component 4.

The operating system of the terminal 2 and/or the camera device 1 controls and monitors the functions of the camera unit 2, in particular the modules 11a, b, c and possibly other modules, such as one or more servomotors, and stores the current state, e.g., the position of the camera unit 3, in the memory module 9a. The operating system also has information describing the camera (type, mode of operation, etc.) in the memory module 9b and the settings of a user in the memory module 9c.

The software components 5 are provided with properties, such as the required permissions B. One component of the operating system is responsible for establishing a connection to the server 8 in the cloud 13. The connection to this server 8 is made using a generic protocol, so that there is no need for the server 8 to understand the operating principle of the camera device 1. A downstream system (not shown) can use the server 8 to communicate with the camera device 1.

The camera device 1, in particular the central component 4, receives a request A1 for a new state to be adopted by the camera unit 2, in particular the modules 11a, b, c and other modules, via the server 8. This can, for example, be a new orientation/position of the camera unit 3 if a user wants to track a person via the cloud 3.

At the same time, the software components 5 on the camera device 1, in particular on the terminal 2, are able to request similar requests A2, A3 relating to a state or changes of state, e.g., when a software component 5 wants to zoom in on a specific object for video analysis.

Since multiple units of the camera unit 3 can make requests A1, A2, A3 relating to a new state/a change of state, the requests A1, A2, A3 can conflict. Moreover, since the state of the camera unit 3 can change during the transmission of the request of the server 8, it is necessary that the server 8 transmits the absolute state as the request A1.

As soon as the central component 4 receives the request A1 for a new state from the server 8, this is compared to the current state AS to ascertain the needed changes of state. It is now possible that the software components 5 have caused changes of state. Therefore, additional information is used to examine changes of state to determine whether these requests are explicit changes of the state of the server 8, dependent changes to recover the original state, or independent changes that can coexist with the target state.

For example, if a movement of the camera unit 3 is requested, it can be assumed that the image is being displayed or processed in the cloud 13 and any image quality settings will have to be restored. On the other hand, a sound output via the sound output module or recording by the sound recording module, for example, would be reconcilable with the movement of the camera unit 3.

If conflicts arise, they are resolved by assigning a priority; i.e., a currently active component is giving priority. This priority can continue for a specific period of time, e.g., to prevent a software component 5 from controlling the camera unit 3 even though someone is still viewing the video image in the cloud 13.

The information that can be included in the evaluation is many and varied. The most obvious source of information is user settings; e.g., if the priority of the components for access has been set. Another source of information is the properties of the camera unit 3. For example, a camera unit can have a 360-degree field of view, of which, for reasons of compatibility with existing software components 5, it makes only a portion available. For such a camera unit 3, a plurality of virtual camera positions would be possible. Lastly, the properties, especially the permissions, of the software components 5 themselves come into play. For example, it is conceivable that an “override user” permission exists, which gives this software component 5 priority. Alternatively, the software component 5 can be a “safety-critical” software component 5, such as a software component 5 for fire detection. This type of software component 5 can then be given priority over a “security-relevant” software component 5.

Once the necessary changes have been ascertained, an action sequence 14 is determined. Certain action steps can be carried out in parallel, whereas others have to take place sequentially. Moving the camera unit 3 and setting a manual focus, for instance, can be carried out in parallel. Autofocusing, on the other hand, has to be carried out only after the movement of the camera unit 3. If necessary, information about the camera unit 3 is used again.

Lastly, the action sequence 14 is implemented by the operating system and/or the control device 12 by actuating the respective actuators in the actuator arrangement and/or the respective modules 11a, b, c, etc. in the camera unit 3.

For example, a request A1 for a new state is made from the cloud 13 via the server 8. Further requests A2 and A3 are made by the software components 5. The requests A1, A2, and A3 overlap in time. The requests, in particular A1 and A2, are moreover mutually exclusive. The central component 4 receives the requests A1, A2 and A3 and compares them with the current state AS of the camera unit 3 and optionally with the most recent state LS, in particular the most recent requested state LS, of the camera unit 3. The central component 4 orchestrates the requests A1, A2 and A3 by arranging them in a chronological order, in particular in the action sequence 14.

The permissions B and priorities derived therefrom, in particular the change priorities of the software components 5, are taken into account in the orchestration. Component priorities of the software components 5 can be taken into account as well. The priority rules can be stored in a set of rules, for instance.

The central component 4 furthermore examines whether the requests A1, A2 and A3 should be processed in parallel or in series. If the requests A1, A2 both relate to the position of the camera unit 3 and are set via the modules 11a, b, c, these requests are processed in series as shown in the action sequence 14. If the request A3 relates to the sound recording module and/or the sound output module, for example, the request A3 is independent of the requests A1 and A2, so that the request A3 can be carried out in parallel to the requests A1 and A2. This is implemented in the action sequence by means of two parallel paths, wherein the requests A1 and A2 are implemented in series on the first path and the request A3 is implemented on the second path parallel to the first path. The action sequence 14 is subsequently implemented by the control device 12 in the actuator arrangement and/or in the modules 11a, b, c and the other modules. The control device 12 can also be a component of the operating system of the terminal 2.

Please amend the listing of claims as follows:

1. A terminal (2) for controlling at least one actuator arrangement, wherein the actuator arrangement can adopt a plurality of states, the terminal comprising:
at least one computer, wherein a state and/or a change of state of the actuator arrangement can be requested by means of the computer via a request (A2, A3),
a central component (4), wherein the central component (4) comprises at least one cloud interface (6) for communicating with at least one cloud (13) and at least one component interface (7) for communicating with the computer, wherein a state and/or a change of state of the actuator arrangement can be requested via the cloud interface (6) and/or the component interface (7) via a request (A1, A2, A3), and
an output interface (10) for controlling the actuator arrangement,
wherein the central component (4) is configured to orchestrate the requested states (A1, A2, A3) and/or changes of state, and
wherein the terminal (2) is configured as a controller of a safety system component.

2. The terminal (1) according to claim 1, wherein the terminal (2) is configured as a camera controller and/or the actuator arrangement is configured as a camera unit (3).

3. The terminal (2) according to claim 1, wherein the component interface (7) is configured as an application programming interface (API).

4. The terminal (2) according to claim 2, wherein the actuator arrangement and/or the camera unit (3) includes a pan module (11a), a tilt module (11b) and/or a zoom module (11c), wherein the terminal (2) is configured to control the modules (11a, b, c).

5. The terminal (2) according to claim 2, wherein the actuator arrangement and/or the camera unit (3) includes a sound recording module and/or a sound output module, wherein the terminal (2) is configured to control the modules.

6. The terminal (2) according to claim 1, wherein the at least one computer is assigned a component priority, wherein the central component (4) is configured to orchestrate the requests (A1, A2, A3) of the software component (4) and/or via the cloud interface (6) taking into account the component priority.

7. The terminal (2) according to claim 1, wherein the requests (A1, A2, A3) are assigned a change priority after a state and/or a change of state, wherein the central component (4) is configured to orchestrate the requests of the computer and/or via the cloud interface (6) taking into account the change priority.

8. The terminal (2) according to claim 1, wherein the orchestrating includes sorting the sequence of requests (A1, A2, A3), wherein an action sequence (14) is output via the output interface (10) based on the sorted requests (A1, A2, A3).

9. The terminal (2) according to claim 1, wherein states and/or changes of state are arranged in the action sequence (14) in series and/or in parallel.

10. A camera comprising:
A terminal (2) for controlling at least one actuator arrangement, wherein the actuator arrangement can adopt a plurality of states, the terminal including,
at least one computer, wherein a state and/or a change of state of the actuator arrangement can be requested by means of the computer via a request (A2, A3),
a central component (4), wherein the central component (4) comprises at least one cloud interface (6) for communicating with at least one cloud (13) and at least one component interface (7) for communicating with the computer, wherein a state and/or a change of state of the actuator arrangement can be requested via the cloud interface (6) and/or the component interface (7) via a request (A1, A2, A3), and
an output interface (10) for controlling the actuator arrangement,
wherein the central component (4) is configured to orchestrate the requested states (A1, A2, A3) and/or changes of state, and
wherein the terminal (2) is configured, to control the actuator arrangement.

11. The camera according to claim 10, wherein the camera is configured as a structural unit.

12. A method for controlling a terminal (2) that includes at least one computer, wherein a state and/or a change of state of the actuator arrangement can be requested by means of the computer via a request (A2, A3), a central component (4), wherein the central component (4) comprises at least one cloud interface (6) for communicating with at least one cloud (13) and at least one component interface (7) for communicating with the computer, wherein a state and/or a change of state of the actuator arrangement can be requested via the cloud interface (6) and/or the component interface (7) via a request (A1, A2, A3), and an output interface (10) for controlling the actuator arrangement, wherein the central component (4) is configured to orchestrate the requested states (A1, A2, A3) and/or changes of state, the method comprising the steps:
accepting at least one request (A1, A2, A3) for a state and/or a change of state of the actuator arrangement;
orchestrating the requested states and/or changes of state.

13. (canceled)

14. (canceled)

15. A non-transitory, machine-readable storage medium containing instructions that when executed by a computer cause the computer to control a terminal that includes at least one computer, wherein a state and/or a change of state of the actuator arrangement can be requested by means of the computer via a request (A2, A3), a central component (4), wherein the central component (4) comprises at least one cloud interface (6) for communicating with at least one cloud (13) and at least one component interface (7) for communicating with the computer, wherein a state and/or a change of state of the actuator arrangement can be requested via the cloud interface (6) and/or the component interface (7) via a request (A1, A2, A3), and an output interface (10) for controlling the actuator arrangement, wherein the central component (4) is configured to orchestrate the requested states (A1, A2, A3) and/or changes of state, by:
accepting at least one request (A1, A2, A3) for a state and/or a change of state of the actuator arrangement; and
orchestrating the requested states and/or changes of state.
